(19) United States
(12) Patent Application Publication
(10) Pub. No.: US 2019/0262975 A1
(43) Pub. Date: Aug. 29, 2019

(54) POLYCRYSTALLINE DIAMOND

(71) Applicant: ELEMENT SIX ABRASIVES S.A., Luxembourg (LX)

(72) Inventors: Kaveshini NAIDOO, Gauteng (ZA); Humphrey Samkelo Lungisani SITHEBE, Gauteng (ZA)

(21) Appl. No.: 16/409,959

(22) Filed: May 13, 2019

Related U.S. Application Data
(63) Continuation of application No. 14/616,638, filed on Feb. 6, 2015, now abandoned.
Application No. 14/616,638 is a continuation of application No. 13/107,590, filed on May 13, 2011, now abandoned.
(60) Provisional application No. 61/334,966, filed on May 14, 2010.

(51) Int. Cl. B24D 99/00; E21B 10/567; B24D 18/00; C04B 35/52; C04B 37/02; C04B 35/628; C04B 35/645

(52) U.S. Cl. CPC B24D 99/005; C04B 2235/405; B24D 18/0009; C04B 35/52; C04B 37/026; C04B 35/62818; C04B 35/62831; C04B 35/62842; C04B 35/62886; C04B 35/62892; C04B 35/645; C04B 2235/408; Y10T 428/256; C04B 2235/404; Y10T 428/30; Y10T 428/268; C04B 2237/401; C04B 2237/363; C04B 2237/123; C04B 2235/786; C04B 2235/783; C04B 2235/427; C04B 2235/3239; C04B 2235/3839; C04B 2235/3843; C04B 2235/441; C04B 2235/5436; C04B 2235/5445; C04B 2235/5472; E21B 10/567

(57) ABSTRACT

A PCD body comprises a skeletal mass of inter-bonded diamond grains defining interstices between them. At least some of the interstices contain a filler material comprising a metal catalyst material for diamond, the filler material containing Ti, W and an additional element M selected from the group consisting of V, Y, Nb, Hf, Mo, Ta, Zr Cr, Zr and the rare earth elements. The content of Ti within the filler material is at least 0.1 weight % and at most 20 weight %. The content of M within the filler material is at least 0.1 weight % and at most 20 weight %, and the content of W within the filler material is at least 5 weight % and at most 50 weight % of the filler material.

### FIELD

This disclosure relates to polycrystalline diamond (PCD) bodies and tools or tool components comprising PCD bodies, particularly but not exclusively for boring into the earth or degrading rock.

### BACKGROUND

Tool components comprising polycrystalline diamond (PCD) are used in a wide variety of tools for cutting, machining, drilling or degrading hard or abrasive materials such as rock, metal, ceramics, composites and wood-containing materials. PCD comprises a mass of substantially inter-grown diamond grains forming a skeletal mass, which defines interstices between the diamond grains. PCD material comprises at least about 80 volume % of diamond and may be made by subjecting an aggregated mass of diamond grains to an ultra-high pressure of greater than about 5 GPa and temperature of at least about 1,200 degrees centigrade in the presence of a sintering aid, also referred to as a catalyst material for diamond. Catalyst material for diamond is understood to be material that is capable of promoting direct inter-growth of diamond grains at a pressure and temperature condition at which diamond is thermodynamically more stable than graphite. Some catalyst materials for diamond may promote the conversion of diamond to graphite at ambient pressure, particularly at elevated temperatures. Examples of catalyst materials for diamond are cobalt, iron, nickel and certain alloys including any of these. PCD may be formed on a cobalt-cemented tungsten carbide substrate, which may provide a source of cobalt catalyst material for the PCD. The interstices within PCD material may be at least partly be filled with the catalyst material. A disadvantage of PCD containing certain catalyst materials for diamond as a filler material may be its reduced wear resistance at elevated temperatures.

U.S. Pat. No. 6,651,757 discloses an insert, which includes an exposed surface having a contact portion that includes a PCD material. In preferred embodiments, an additional material, referred to as a “second phase” material, is added to diamond crystals to reduce the inter-crystalline bonding. The second phase material may be metal such as W, V or Ti.

U.S. Pat. No. 7,553,350 discloses a high-strength and highly-wear-resistant sintered diamond object including sintered diamond particles having an average particle size of at most 2 microns and a binder phase as a remaining portion. The binder phase contains at least one element selected from the group consisting of titanium, zirconium, hafnium, vanadium, niobium, tantalum, chromium and molybdenum of which content is at least 0.5 mass % and less than 50 mass % and contains cobalt of which content is at least 50 mass % and less than 99.5 mass %. In one embodiment, the sintered diamond object, at least one element selected from the group consisting of Ti, Zr, Hf, V, Nb, Ta, Cr and Mo is Ti, and the content of Ti in the binder phase is preferably at least 0.5 mass % and less than 20 mass %. The purpose of the additive is to suppress abnormal growth of the fine diamond grains. The PCD material is particularly for a cutting tool represented by a turning tool, a milling tool, an end mill, a wear-resistant tool, a drawing die, machine tool, and to application in an electronic material such as an electrode part.

There is a need for PCD material having enhanced impact resistance and good wear resistance, particularly in the application of cutting or boring into rock.

### SUMMARY

Viewed from a first aspect there is provided a PCD body comprising a skeletal mass of inter-bonded diamond grains defining interstices between them, at least some of the interstices containing a filler material comprising a metal catalyst material for diamond, such as cobalt, iron, manganese or nickel, the filler material containing Ti, W and an additional element M selected from the group consisting of V, Y, Nb, Hf, Mo, Ta, Cr, Zr and the rare earth elements such as Ce and La; the content of Ti within the filler material being at least about 0.1 weight % or at least about 0.5 weight % and at most about 10 weight % or at most about 20 weight %; the content of M within the filler material being at least about 0.1 weight % or at least about 0.5 weight % and at most about 10 weight % or at most about 20 weight %; and the content of W within the filler material being at least about 5 weight % or at least about 10 weight % and at most about 30 weight % or at most about 50 weight % of the filler material.

In one embodiment, M may be selected from the group consisting of V, Y, Nb, Hf, Mo, Ta, Cr and Zr. In some embodiments, the additional metal M may be V and the combined content of Ti and V may be at least about 0.5 weight % or at least about 1 weight % and at most about 5 weight % or at most about 10 weight % of the filler material. In some embodiments, the filler material may comprise at least about 50 weight % Co, at least about 70 weight % Co, at least about 90 weight % Co or at least about 95 weight % Co, and in one embodiment the filler material may comprise at most about 99 weight % Co.

In one embodiment, the filler material may comprise a particulate phase dispersed therein. In one embodiment, the particulate phase may comprise a mixed carbide phase containing Ti, M and W, and in one embodiment, the particulate phase may comprise a mixed carbide phase containing cobalt.

Embodiments may comprise mixed carbide particulates finely dispersed in the filler material, the mixed carbide being of the formula (Ti, W, V)ₓC_{y}. For example, embodiments of the PCD body may comprise particulates comprising W_{0.37}V_{0.63}Cₓ or W_{0.40}Ti_{0.37}V_{0.23}Cₓ, or both, dispersed in the filler material. In some embodiments, eta phase particulates may be dispersed in the filler material, the eta phase having the formula Co_{z}(Ti, W, V)ₓC_{y}. In some embodiments, z may be at least about 3 and at most about 6, and in some embodiments, x may be at least about 3 and at most about 6. In one embodiment, y may be about 1. For example, embodiments of the PCD body may comprise eta phase particulates comprising Co₃W₃C or Co₆W₆C dispersed in the filler material.

In some embodiments, the particulate phase may be in the form of particles having a mean size of at least about 100 nm or at least about 200 nm, and in some embodiments, the particles of the particulate phase may have a mean size of at most about 1,000 nm. In one embodiment, at most about 10% or at most 5% of the particles of the particulate phase may have a size greater than about 1,000 nm.

In some embodiments, the diamond grains may have a mean size of greater than 2 microns or at least about 3 microns. In some embodiments, the diamond grains may have a mean size of at most about 10 microns or even at most about 5 microns.

In some embodiments, the PCD body may have a diamond grain contiguity of at least about 62 percent or at least about 64 percent. In some embodiments, the superhard grain contiguity may be at most about 92 percent, at most about 85 percent or even at most about 80 percent.

In some embodiments, the PCD body may comprise at least about 85 volume % or at least about 88 volume % diamond, and in one embodiment, the PCD body may comprise at most about 99 volume % diamond.

In one embodiment, the PCD body may comprise diamond grains having a multi-modal size distribution, and in one embodiment the diamond grains may have a bi-modal size distribution.

Viewed from a further aspect there is provided a method for making a PCD body comprising introducing Ti and additional metal M into an aggregated mass of diamond grains; M being selected from the group consisting of V, Y, Nb, Hf, Mo, Ta, Cr, Zr and rare earth metals such as Ce and La; placing the aggregate mass onto a cobalt-cemented WC substrate to form a pre-sinter assembly and subjecting the pre-sinter assembly to a pressure and temperature at which diamond is more thermodynamically stable than graphite and at which the cobalt in the substrate is in a liquid state, for example a pressure of at least about 5.5 GPa and a temperature of at least about 1,350 degrees centigrade, and sintering the diamond grains together to form a PCD body bonded to the substrate.

In some embodiments, the method may comprise subjecting the pre-sinter assembly to a pressure of at least about 6.0 GPa, at least about 6.5 GPa, at least about 7 GPa or even at least about 7.5 GPa. In one embodiment, the pressure may be at most about 8.5 GPa.

In one embodiment, the method may comprise introducing the Ti into the aggregated mass in the form of TiC particles.

In one embodiment, the method may comprise introducing the V into the aggregated mass in the form of VC particles.

Embodiments of the method may include subjecting the PCD body to a heat treatment at a temperature of at least about 500 degrees centigrade, at least about 600 degrees centigrade or at least about 650 degrees centigrade for at least about 30 minutes. In some embodiments, the temperature may be at most about 850 degrees centigrade, at most about 800 degrees centigrade or at most about 750 degrees centigrade. In some embodiments, the PCD body may be subjected to the heat treatment for at most about 120 minutes or at most about 60 minutes. In one embodiment, the PCD body may be subjected to the heat treatment in a vacuum.

Embodiments of a tool or tool element are provided, comprising an embodiment of a PCD body described above.

In some embodiments, the tool or tool element may be suitable for cutting, milling, grinding, drilling or boring into rock. In one embodiment, the tool element may be an insert for a drill bit for boring into the earth, as may be used in the oil and gas drilling industry, and in one embodiment, the tool is a drill bit for boring into the earth.

### BRIEF DESCRIPTION OF THE DRAWINGS

Non-limiting embodiments will now be described by way of example and with reference to the accompanying drawings in which:

FIG. 1 shows a schematic perspective view of an embodiment of a PCD cutter insert for a shear cutting drill bit for boring into the earth; and

FIG. 2 shows a schematic cross section view of an embodiment of a PCD cutter insert together with a schematic expanded view showing the microstructure of an embodiment of the PCD material.

The same reference numbers refer to the same respective features in all drawings.

### DETAILED DESCRIPTION OF EMBODIMENTS

As used herein, “PCD material” is a material that comprises a mass of diamond grains, a substantial portion of which are directly inter-bonded with each other and in which the content of diamond is at least about 80 volume % of the material. In one embodiment of PCD material, interstices among the diamond gains may be at least partly filled with a binder material comprising a catalyst for diamond.

As used herein, “catalyst material for diamond” is a material that is capable of promoting the growth of diamond or the direct diamond-to-diamond inter-growth between diamond grains at a pressure and temperature at which diamond is thermodynamically more stable than diamond.

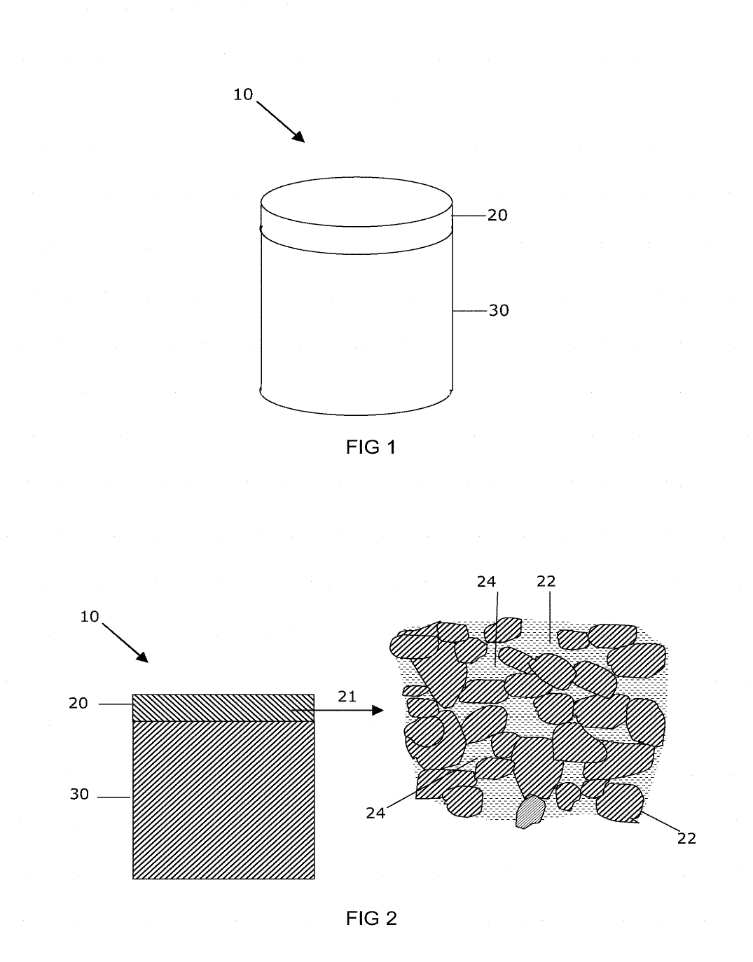

FIG. 1 shows an embodiment of a PCD cutter insert 10 for a drill bit (not shown) for boring into the earth, comprising a PCD body 20 bonded to a cemented tungsten carbide substrate 30.

FIG. 2 shows an embodiment of a PCD cutter insert 10 for a drill bit (not shown) for boring into the earth, comprising a PCD body 20 bonded to a cemented tungsten carbide substrate 30. The microstructure 21 of the PCD body 20 comprises a skeletal mass of inter-bonded diamond grains 22 defining interstices 24 between them, the interstices 24 being at least partly filled with a filler material comprising cobalt. The filler material in the interstices 24 may contain Ti, W and V, the content of Ti within the filler material being about 1 weight % of the filler material, the content of V within the filler material being about 2 weight % of the filler material and the content of W within the filler material being about 20 weight % of the filler material.

PCT application publication number WO2008096314 discloses a method of coating diamond particles, which has opened the way for producing a host of polycrystalline ultrahard abrasive elements or composites, including polycrystalline ultrahard abrasive elements comprising diamond in a matrix selected from materials selected from a group including VN, VC, HfC, NbC, TaC, Mo₂C, WC.

In one embodiment, the PCD body is heat treated at a temperature of at least about 500 degrees centigrade and at most about 850 degrees centigrade. Whilst not wishing to be bound by a particular theory, the heat treatment may promote the formation of mixed carbide eta phases, particularly phases such as Co_{z}(Ti,W,V)ₓC_{y}.

As used herein, the “equivalent circle diameter” (ECD) of a particle is the diameter of a circle having the same area as a cross section through the particle. The ECD size distribution and mean size of a plurality of particles may be measured for individual, unbonded particles or for particles bonded together within a body, by means of image analysis of a cross-section through or a surface of the body.

As used herein, a “multimodal size distribution” of a mass of grains includes more than one peak, or that can be resolved into a superposition of more than one size distribution each having a single peak, each peak corresponding to a respective “mode”. Multimodal polycrystalline bodies are typically made by providing more than one source of a plurality of grains, each source comprising grains having a substantially different average size, and blending together the grains or grains from the sources.

As used herein, “grain contiguity”, K, is a measure of grain-to-grain contact or bonding, or a combination of both contact and bonding, and is calculated according to the following formula using data obtained from image analysis of a polished section of polycrystalline superhard material:

κ=100*[2*(δ−β)]/[(2*(δ−β))+δ], where δ is the superhard grain perimeter, and β is the binder perimeter.

The superhard grain perimeter is the fraction of superhard grain surface that is in contact with other superhard grains. It is measured for a given volume as the total grain-to-grain contact area divided by the total superhard grain surface area. The binder perimeter is the fraction of superhard grain surface that is not in contact with other superhard grains. In practice, measurement of contiguity is carried out by means of image analysis of a polished section surface, and the combined lengths of lines passing through all points lying on all grain-to-grain interfaces within the analysed section are summed to determine the superhard grain perimeter, and analogously for the binder perimeter.

In order to obtain a measure of the sizes of grains or interstices within a polycrystalline structure, a method known as “equivalent circle diameter” may be used. In this method, a scanning electron micrograph (SEM) image of a polished surface of the PCD material is used. The magnification and contrast should be sufficient for at least several hundred diamond grains to be identified within the image. The diamond grains can be distinguished from metallic phases in the image and a circle equivalent in size for each individual diamond grain can be determined by means of conventional image analysis software. The collected distribution of these circles is then evaluated statistically. Wherever diamond mean grain size within PCD material is referred to herein, it is understood that this refers to the mean equivalent circle diameter. Generally, the larger the standard deviation of this measurement, the less homogenous is the structure.

Embodiments of PDC cutting elements may also be used as gauge trimmers, and may be used on other types of earth-boring tools. For example, embodiments of cutting elements may also be used on cones of roller cone drill bits, on reamers, mills, bi-centre bits, eccentric bits, coring bits, and so-called hybrid bits that include both fixed cutters and rolling cutters.

Images used for the image analysis may be obtained by means of scanning electron micrographs (SEM) taken using a backscattered electron signal. By contrast, optical micrographs generally do not have sufficient depth of focus and give substantially different contrast. Adequate contrast is important for the measurement of contiguity since inter-grain boundaries may be identified on the basis of grey scale contrast.

The contiguity may be determined from the SEM images by means of image analysis software. In particular, software having the trade name analySIS Pro from Soft Imaging System® GmbH (a trademark of Olympus Soft Imaging Solutions GmbH) may be used. This software has a “Separate Grains” filter, which according to the operating manual only provides satisfactory results if the structures to be separated are closed structures. Therefore, it is important to fill up any holes before applying this filter. The “Morph. Close” command, for example, may be used or help may be obtained from the “Fillhole” module. In addition to this filter, the “Separator” is another powerful filter available for grain separation. This separator can also be applied to colour- and grey-value images, according to the operating manual.

Embodiments are now described in more detail with reference to the examples below, which are not intended to be limiting.

### Example 1

A bi-modal blend of diamond powder was prepared by blending together diamond grains two different sources, the mean size of the diamond grains in the first source being about 2 microns and in the second source being about 5 microns to form an aggregate blended mass of diamond grains. The blended diamond grains were treated in acid to remove surface impurities that may have been present. Vanadium carbide and titanium carbide was then introduced into the diamond powder blend by blending particles of VC and particles of TiC with the diamond powder using a planetary ball mill. The mean size of the TiC particles was about 3 microns and the mean size of the VC particles was about 4 microns. The content of TiC particles in the powder was about 0.5 weight % of the diamond powder and the content of the VC particles was about 0.5 weight % of the diamond powder.

An aggregate mass of the coated diamond powder was placed onto a Co-cemented WC substrate and encapsulated to form a pre-sinter assembly, which was then out-gassed in a vacuum to remove surface impurities from the diamond grains. The pre-sinter assembly was subjected to a pressure of about 6.5 GPa and a temperature of about 1,550 degrees centigrade in an ultra-high pressure furnace to sinter the diamond grains and form a PCD compact comprising a layer of PCD material integrally formed with the carbide substrate. During the sintering process, molten cobalt from the substrate and containing dissolved W or WC, or both, in solution infiltrated into the aggregate mass of diamond grains. Image analysis of the PCD material revealed that the content of diamond was about 89 volume %, the diamond grain contiguity was about 62% and the mean size of the sintered diamond grains was about 3.8 microns in terms of equivalent circle diameter.

The PCD compact was processed to form a test PCD cutter insert, which was subjected to a wear test. The wear test involved using the insert in a vertical turret milling apparatus to cut a length of a workpiece material comprising granite until the insert failed by fracture or excessive wear. The distance cut through the workpiece before the insert was deemed to have failed may be an indication of expected working life in use. For comparison, a control PCD cutter insert was prepared in the same way as the test cutter, except that V and Ti were not introduced. The cutting distance achieved with the test insert was almost double that achieved with the control insert, and the wear scar on the test insert was about 30% less than that evident on the control insert.

### Example 2

A test PCD cutter insert and a control PCD cutter were made and tested as described in Example 2, except that the content of TiC particles in the powder was about 1.5 weight % of the diamond powder and the content of the VC particles was about 1.5 weight % of the diamond powder prior to sintering. The cutting distance achieved with the test insert was about 40% greater than that achieved with the control insert, and the wear scar on the test insert was about half of that evident on the control insert.

### Example 3

A tri-modal blend of diamond powder was prepared by blending together diamond grains three different sources, the mean size of the diamond grains in the first source being about 0.8 microns, the mean size of the diamond grains in the second source being about 2 microns and the mean size of the diamond grains being about 10 microns to form an aggregate blended mass of diamond grains. The blended diamond grains were treated in acid to remove surface impurities that may have been present. Vanadium carbide and titanium carbide was then introduced into the diamond powder blend by blending particles of VC and particles of TiC with the diamond powder using a planetary ball mill. The mean size of the TiC particles was about 3 microns and the mean size of the VC particles was about 4 microns. The content of TiC particles in the powder was about 1.5 weight % of the diamond powder and the content of the VC particles was about 1.5 weight % of the diamond powder.

An aggregate mass of the coated diamond powder was placed onto a Co-cemented WC substrate and encapsulated to form a pre-sinter assembly, which was then out-gassed in a vacuum to remove surface impurities from the diamond grains. The pre-sinter assembly was subjected to a pressure of about 6.5 GPa and a temperature of about 1,550 degrees centigrade in an ultra-high pressure furnace to sinter the diamond grains and form a PCD compact comprising a layer of PCD material integrally formed with the carbide substrate. During the sintering process, molten cobalt from the substrate and containing dissolved W or WC, or both, in solution infiltrated into the aggregate mass of diamond grains. The mean size of the sintered diamond grains was about 6 microns in terms of equivalent circle diameter.

The PCD compact was processed to form a test PCD cutter insert, which was subjected to a wear test. The wear test involved using the insert in a vertical turret milling apparatus to cut a length of a workpiece material comprising granite until the insert failed by fracture or excessive wear. The distance cut through the workpiece before the insert was deemed to have failed may be an indication of expected working life in use. For comparison, a control PCD cutter insert was prepared in the same way as the test cutter, except that V and Ti were not introduced. The cutting distance achieved with the test insert was more than double that achieved with the control insert, although the wear scar on the test insert was almost double that evident on the control insert.

### Example 4

A bi-modal blend of diamond powder was prepared by blending together diamond grains two different sources, the mean size of the diamond grains in each source being about 2 microns and 5 microns, respectively, to form an aggregate blended mass of diamond grains having a mean size of about 3.8 microns. The blended diamond grains were treated in acid to remove surface impurities that may have been present.

Vanadium carbide was then introduced into the diamond powder blend by depositing V onto the diamond grains in a suspension. The diamond powder was suspended in ethanol and vanadium tri-isopropoxide precursor (an organic compound) and deionised water was then fed into the suspension in a controlled, dropwise manner. The concentration of the precursor was calculated to achieve a particular concentration of VC precipitated onto the diamond grains. Over a period of about 400 minutes, the vanadium-containing organic precursor converted to vanadium pentoxide (V₂O₅) compound precipitated onto the diamond grains. The ethanol was then evaporated and the coated diamond dried in a vacuum oven overnight at about 100 degrees centigrade. A further coating comprising CoCO₃ was then deposited onto the diamond grains by a known means, to form a diamond powder comprising diamond grains having V₂O₅ and CoCO₃ microstructures deposited on the grain surfaces. This powder was then subjected to a heat treatment in a hydrogen atmosphere to reduce the vanadium pentoxide to vanadium carbide and the CoCO₃ to Co. XRD analysis showed that the VC and Co were present on the surfaces of the diamond grains and SEM analysis showed that these were in the form of finely dispersed particles distributed over the grain surfaces. Particles of TiC were then blended with the coated diamond powder to form a blended powder, in which the TiC content was about 1.5 weight % of the diamond powder and the VC content was about 1.5 weight % of the diamond powder.

An aggregate mass of the blended powder was placed onto a Co-cemented WC substrate and encapsulated to form a pre-sinter assembly, which was then out-gassed in a vacuum to remove surface impurities from the diamond grains. The pre-sinter assembly was then subjected to a pressure of about 6.5 GPa and a temperature of about 1,550 degrees centigrade in an ultra-high pressure furnace to sinter the diamond grains and form a PCD compact comprising a layer of PCD integrally formed with the carbide substrate. During the sintering process, molten cobalt from the substrate and containing dissolved W or WC in solution infiltrated into the aggregate mass of diamond grains.

Some embodiments may have the advantage of enhanced abrasive wear resistance and extended working life, particularly when used in the cutting of rock. Embodiments in which the mean diamond grain size is greater than about 2 microns may generally have higher strength and fracture resistance.

Whilst not wishing to be bound by any particular theory, the combination of Ti and metal M additives within the filler material may result in a very fine dispersion of particles containing Ti, M or W, or certain combinations of these elements, within the filler material in some embodiments. In some embodiments, this may have the effect of better dispersing the energy of cracks arising and propagating within the PCD material in use, resulting in altered wear behaviour of the PCD material and enhanced resistance to impact and fracture, and consequently extended working life in some applications.

Whilst not wishing to be bound by any particular theory, the advantage of introducing the Ti or the metal M, or both, in the form of the respective carbide compound may arise from the fact that co-introduction of O is limited or avoided, since the oxide form of Ti is very stable and oxygen may deleteriously affect the sintering of diamond grains to form PCD.

Although the foregoing description of PCD bodies, tools, manufacturing methods and various applications contain many specifics, these should not be construed as limiting, but merely as providing illustrations of some example embodiments. Similarly, other embodiments may be devised which do not depart from the spirit or scope of the present invention.

1. A PCD body comprising a skeletal mass of inter-bonded diamond grains defining interstices between them, at least some of the interstices containing a filler material comprising a metal catalyst material for diamond, the filler material containing Ti, W and an additional metal M selected from the group consisting of V, Y, Nb, Hf, Mo, Ta, Cr, Zr and the rare earth elements; the content of Ti within the filler material being at least about 0.1 weight % and at most about 20 weight %; the content of M within the filler material being at least about 0.1 weight % and at most about 20 weight %; and the content of W within the filler material being at least about 5 weight % and at most about 50 weight % of the filler material.

2. A PCD body as claimed in claim 1, wherein the additional metal M is V and the combined content of Ti and V is at least about 0.5 weight % and at most about 10 weight % of the filler material.

3. A PCD body as claimed in claim 1, wherein the filler material comprises at least about 50 weight % Co and at most about 99 weight % Co.

4. A PCD body as claimed in claim 1, wherein the filler material comprises a particulate phase dispersed therein, the particulate phase comprising a mixed carbide phase containing Ti, M and W.

5. A PCD body as claimed in claim 4, the particulate phase being in the form of particles having a mean size of at least about 100 nm at most about 1,000 nm.

6. A PCD body as claimed in claim 1, the diamond grains having a mean size of greater than about 2 microns.

7. A PCD body as claimed in claim 1, the PCD body having a diamond grain contiguity of at least about 62 percent.

8. A PCD body as claimed in claim 1, comprising diamond grains having a bi-modal size distribution.

9. A method for making a PCD body comprising: introducing Ti and additional metal M into an aggregated mass of diamond grains; M being selected from the group consisting of V, Y, Nb, Hf, Mo, Ta, Cr, Zr and rare earth metals such as Ce and La; placing the aggregate mass onto a cobalt-cemented WC substrate to form a pre-sinter assembly and subjecting the pre-sinter assembly to a pressure and temperature at which diamond is more thermodynamically stable than graphite and at which the cobalt in the substrate is in a liquid state, and sintering the diamond grains together to form a PCD body bonded to the substrate.

10. A method as claimed in claim 9, further comprising subjecting the pre-sinter assembly to a pressure of at least about 6.0 GPa.

11. A method as claimed in claim 9, further comprising introducing the Ti into the aggregated mass in the form of TiC particles.

12. A method as claimed in claim 9, further comprising subjecting the PCD body to a heat treatment at a temperature of at least 500 degrees centigrade and at most about 850 degrees centigrade for at least about 30 minutes and at most about 120 minutes.

13. A tool or tool element comprising the PCD body as claimed in claim 1.

14. A tool or tool element as claimed in claim 13, suitable for cutting, milling, grinding, drilling or boring into rock.

15. A tool or tool element as claimed in claim 13, the tool element being an insert for a drill bit for boring into the earth and the tool being a drill bit for boring into the earth.
